(19) United States
(12) Patent Application Publication
(10) Pub. No.: US 2005/0266828 A1
(43) Pub. Date: Dec. 1, 2005

(54) Apparatus and method for theft prevention using a digital radio

(76) Inventors: Mahmut Ciftci, Missouri City, TX (US); Burc Simsek, SugarLand, TX (US); Trudy D. Stetzler, Houston, TX (US)

Correspondence Address: TEXAS INSTRUMENTS INCORPORATED, P O BOX 655474, M/S 3999, DALLAS, TX, 75265, US

(21) Appl. No.: 10/853,082

(22) Filed: May 25, 2004

(51) Int. Cl. H04B 15/00

(52) U.S. Cl. 455/411

(57) ABSTRACT

A digital radio includes an identification number available only to the digital radio itself. A transmitted band received by the digital radio includes an identification number in an information channel. When the two identification numbers match, then the digital radio performs at least one function included in the information channel or, accesses a preselected procedure. In either situation, the presence of the matching identification number in an information channel results in the execution of instructions causing the digital radio to suspend operation, e.g., by deleting certain files. These digital radio can only be reactivated by the manufacturer, e.g., by the reinstallation of the deleted files. In this manner, the digital radio, being inoperative, is useless to a thief. In addition, one of the activities enabled by the identifying number in the information channel, when the digital radio is installed in a vehicle, can be the disabling of the vehicle.

### FIELD OF THE INVENTION

This invention relates generally to digital radios and, more particularly, to techniques for preventing and/or discouraging the theft of the digital radios. As digital radios gain functionality and cost, they become increasingly attractive targets for theft.

### BACKGROUND OF THE INVENTION

With the increasing acceptance of digital radios having the capability to receive non-program related digital data from radio stations, new applications for using the data channel(s) have begun to appear and are currently in design throughout the industry. One new application area for the digital radio is in the field of preventing/deterring theft of the digital radio itself and the vehicle in which the digital radio is installed.

One of the most effective theft prevention methods in place today and widely used by nation's police forces is the LoJack system. This system relies on a hidden electronic device that the installer can activate by means of a remote signal. The location of the radio can be determined when the activated electronic device responds.

Aftermarket radios have various different theft-deterrence features such as removable faceplates, removable units, secret codes and units attached to the vehicles auto alarm system. While taking the radio with you is probably the most effective way to prevent theft, it is also the most inconvenient. Removable faceplates permit the unit to look as if the cavity occupied by the radio is empty. However, an experienced criminal can overcome this technique by replacing the faceplate, and connecting the radio to the vehicles alarm system is only effective for the duration of time in which the unit is being removed.

A more effective way to deter the theft of the radio unit or the vehicle containing the unit would be to insure that if the radio unit is stolen, it will be of no use the thief.

A need has therefore been felt for apparatus and an associated method having the feature that a digital radio is provided with theft-deterrent technique. It would be yet another feature of the apparatus and associated method that the theft-deterrent technique be operative even after the digital radio has been stolen. It would be still another feature of the apparatus and associated method to permit the digital radio to be rendered inoperative by a remote facility. It would be a still further feature of the apparatus and associated method to permit a signal from a broadcast station target a particular digital radio for shut down.

### SUMMARY OF THE INVENTION

The aforementioned and other features are accomplished, according to the present invention, by providing a digital radio with capability of receiving and decoding an information channel in the broadcast band. The digital radio is provided with an identification number accessible only to the digital radio itself. When a digital radio is stolen, the owner contacts a broadcast facility; the broadcast facility transmits instructions in the information channel that can only be executed by a digital radio having the identification number transmitted in the broadcast information channel. The digital radio, upon receipt of the proper identification number, executes the instructions transmitted by the information channel. The instructions can take the form of an activity to be performed by the digital radio or can access instructions to be executed already stored in the digital radio. Whether the instructions are transmitted over the broadcast information channel or are stored in the digital radio, the net effect is to perform an activity the result of which is to effectively prevent further operation of the digital radio. For example, the instructions can result in the erasure of selected files necessary to the functioning of the digital radio. The erased files can only be restored at the factory. One of the instructions, whether stored or transmitted, can cause a control signal to be transmitted to the associated vehicle in which the digital located to disable vehicle, activate an alarm, and/or identify the stolen vehicle.

Other features and advantages of the present invention will be more clearly understood upon reading of the following description and the accompanying drawings and claims.

### BRIEF DESCRIPTION OF THE DRAWINGS

FIG. 1 is a block diagram of a digital radio according to the present invention.

FIG. 2 is a block diagram of the system used in the deterrence of the theft of digital radios according to the present invention.

FIG. 3 illustrates the procedure for deterring the theft of a digital radio according to the present invention.

### DETAILED DESCRIPTION OF THE PREFERRED EMBODIMENT

### DETAILED DESCRIPTION OF THE DRAWINGS

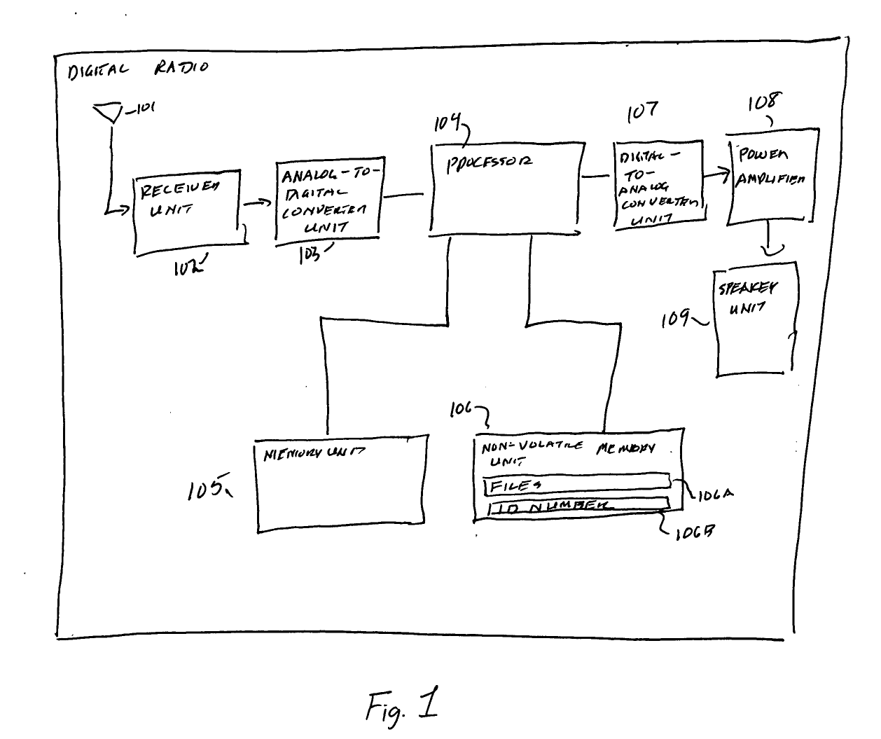

Referring to FIG. 1, a block diagram of a digital radio 10 capable of advantageously using the present invention is shown. The digital radio 10 includes an antenna 101 for receiving the broadcast bands. The broadcast bands typically include a plurality of channels including at least one digitally-encoded channel. One of the channels, typically a digitally encoded channel, is an information channel and includes information concerning the accompanying program, and/or other information to be communicated to the user of the digital radio 10. The signals from the antenna 101 are applied to receiver unit 102. In receiver unit 102, the broadcast band is selected; the signals on the broadcast band frequency are down-converted in frequency, and demodulated. The resulting signals from the receiver unit 102 are applied to the analog-to-digital converter unit 103 wherein all the channels in the broadcast band are converted to at least one digital signal stream and applied to the processor unit 104. The processor unit 104 is typically a digital signal processor because of the amount of repetitious processing needed to decode the digital signal streams(s) and to process the audio performance. The processor 104 has coupled thereto a memory unit 105 and a non-volatile memory unit 106. The non-volatile memory unit 106 can store an identification number 106A or the identification can be stored in hardware. Wherever the identification number 106A is stored, this number is available only to the components of the digital radio 10 and can not be accessed from outside the digital radio 10. The processor 104 can also provide a signal external to the digital radio 10, the use of which will be discussed below. The output of the processor 104 is a processed performance signal steam that is applied to digital-to-analog converter 107. The output signals of the digital-to-analog converter unit 107 are applied to power amplifier(s) 108. The output signal(s) of the power amplifier(s) is/(are) to speaker unit(s).

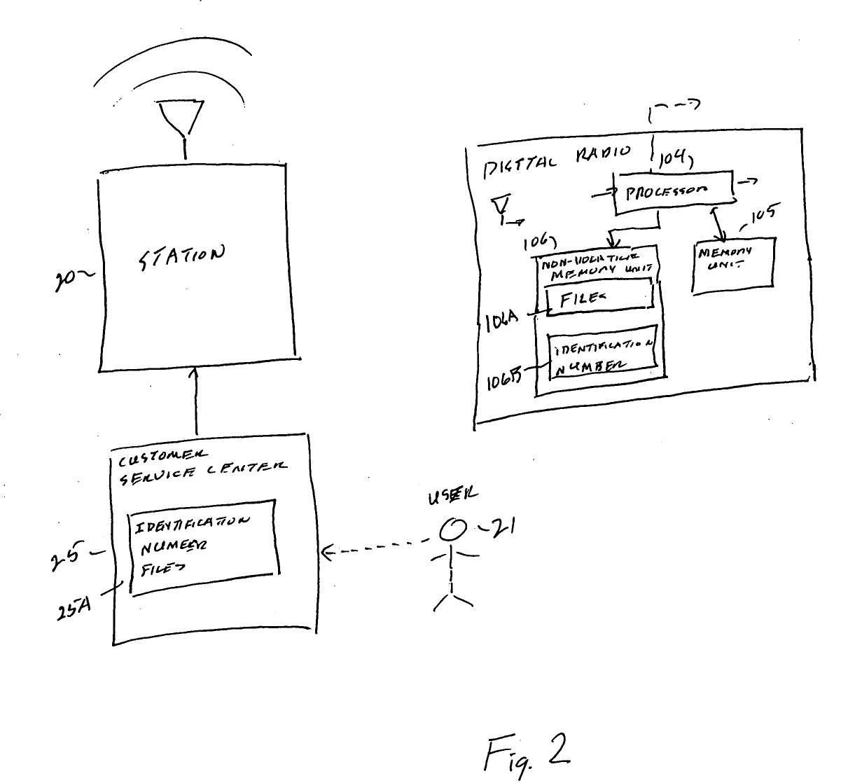

Referring to FIG. 2, the system for implementing the present invention is shown. The system includes a broadcasting station 20 capable of broadcasting a digital radio broadcast band that includes an information channel. A user 21, whose digital radio 10 has been stolen, contacts a facility, such as customer service center 25 that can correlate the user identification with the identification number of the stolen radio. The customer service center 25 then notifies the station 20 of the identification number and the circumstances concerning the stolen radio. In response, the station 20 broadcasts a broadcast band having a message that includes the identification number and at least one instruction. The digital radio 10, upon receipt of the broadcast band, compares the identification number in the band with the digital radio identification number. When the two numbers are the same, the digital radio executes the accompanying instruction(s). The accompanying instruction(s) can cause the digital radio 10 to shut down, or can reference a group of instructions stored in the memory units of the digital radio. The execution of the instructions results in the shut-down of the digital radio.

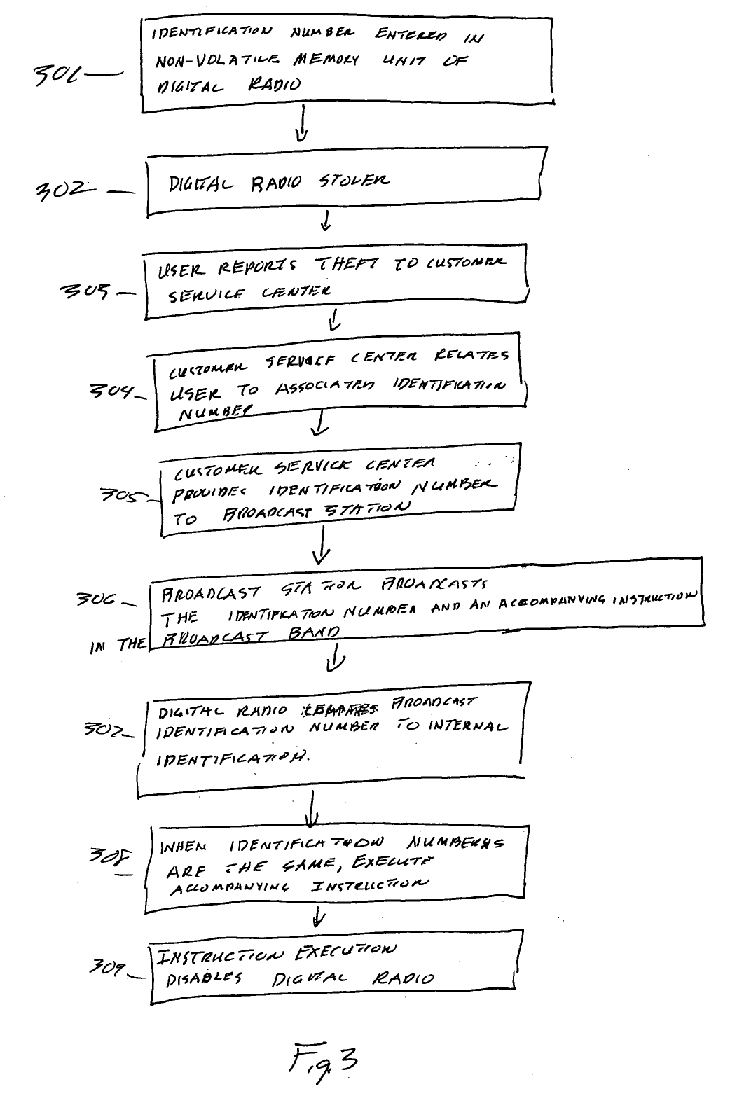

Referring to FIG. 3, the procedure for implementing the present invention is shown. In step 301, at the time of manufacture, an identification number is entered in a non-volatile memory. The digital radio in which the identification number has been entered is stolen in step 302. In step 303, the user reports the theft of the digital radio to a customer service center or other organization associated with the manufacturer. The customer service center relates the user to the identification number in step 304. In step 305, the customer service center provides the identification number to at least broadcast station in the vicinity of the user. In the preferred embodiment, all digital radio broadcast stations would be provided with the identification number. In step 306, the broadcast station(s) broadcasts the identification number and an accompanying instruction in one of the channels of the broadcast band. The digital radio receives the broadcast band from the broadcast station and demodulates and decodes the identification number and the accompanying instruction(s). The digital radio compares the broadcast identification number with the identification number stored in the digital radio in step 307. In step 308, when the identification numbers are the same, the accompanying instruction is executed. The execution of the instruction(s) results in the digital radio being disabled. The accompanying instruction(s) can specify the activity resulting in the disablement of the digital radio or can retrieve an instruction group stored in the digital radio that can disable the digital radio.

### Operation of the Preferred Embodiment

The present invention does not prevent the theft of the digital radio, but rather prevents a thief from enjoying or profiting from the theft. The user communicates to the station or stations the identification number of the digital radio that has been stolen. (Note the user does not have direct access to the identification number, and must contact the manufacturer to determine this number.) However, the identification number of the stolen digital radio is determined; this number is communicated to at least one station and preferably to all stations. The identification number is then transmitted in one of the channels, typically the information channel of the broadcast band. The digital radio when activated and tuned to a channel including the identification number, identifies the presence of the identification number. This identification can do one of two things, an instruction sequence in channel containing the identification can be executed or the identification number can trigger the execution of an internal code sequence. In either situation, whether the instruction set is transmitted with the identification number or is stored in the digital radio, the net result is to shut down the digital radio. The shut-down can be performed by erasing essential files, activating a switch, or whatever technique appears to most appropriate.

If the stolen digital radio is recovered, the present invention envisions the support of the manufacturer to reinstall deleted files, reset a switch, etc. and reverse the disablement of the digital radio.

The digital radio can provide a signal to a vehicle in which the radio is installed. This signal can halt the operation of the vehicle, can activate the vehicle alarm, or activate whatever procedure has been selected to minimize the value of the vehicle to a thief.

While the invention has been described with respect to the embodiments set forth above, the invention is not necessarily limited to these embodiments. Accordingly, other embodiment variations, and improvements not described herein, are not necessarily excluded from the scope of the invention, the scope of the invention being defined by the following claims.

1. A digital radio comprising:
an internal identification number; and
a processor, the processor comparing the internal identification number with a broadcast identification number;
when the internal and the external identification numbers are the same, the processor executing at least one instruction disabling the digital radio.

2. The digital radio as recited in claim 1 wherein the at least one instruction is transmitted along with the external identification number.

3. The digital radio as recited in claim 1 wherein an instruction set is stored in the processor, an external instruction identifying the instruction set accompanying the external identification number;
when the internal and the external identification numbers are the same, the external instruction causes the instruction set to be executed, execution of the instruction set disabling the digital radio.

4. The digital radio as recited in claim 1 wherein the internal identification number is accessible only to the digital radio.

5. A method for disabling a digital radio, the method comprising:
comparing an externally transmitted identification number with an internally stored identification number;
when the external and the internal identification numbers are the same, disabling the digital radio.

6. The method as recited in claim 5 further comprising broadcasting the external identification number when the digital radio has been stolen.

7. The method as recited in claim 5 further comprising broadcasting the external identification number in response to a communication to a file storage center by a user.

8. The method as recited in claim 7 further comprising notifying a broadcast station of an external identification in response to the communication by the user.

9. The method as recited in claim 5 further comprising broadcasting instructions for disabling digital radio along with the external identification code.

10. The method as recited in claim 5 further comprising storing the internal identification number such that the internal identification is accessible only to the digital radio.

11. A system comprising:
a digital radio, the digital radio storing an internal identification number, the digital radio being disabled when a broadcast external identification signal is the same as the internal identification signal;
an information center, the information center determining an external identification number in response to a communication from a user; and
a broadcast station responsive to receipt of the external identification number for transmitting the external identification number received from the information center.

12. The system as recited in claim 11 wherein the external identification number is transmitted with at least one accompanying instruction.

13. The system as recited in claim 12 wherein the at least one accompanying instruction disables the digital radio when the external identification and the internal identification are the same.

14. The system as recited in claim 12 wherein the at least one accompanying instruction accesses a stored instruction set, the stored instruction set disabling the digital radio when the external identification number is the same as the internal identification number.

15. The system as recited in claim 12 wherein the internal identification number can only be accessed by the digital radio.
